(19) United States
(12) Patent Application Publication
(10) Pub. No.: US 2014/0198312 A1
(43) Pub. Date: Jul. 17, 2014

(54) LASER ALIGNMENT SYSTEM FOR MEASURING AN ALIGNMENT OF ROTATING MACHINE PARTS AND METHOD FOR PREPROCESSING MEASUREMENT RESULTS OF A LASER ALIGNMENT SYSTEM

(71) Applicant: Matthias Gitzen, Aachen (DE)

(72) Inventor: Matthias Gitzen, Aachen (DE)

(73) Assignee: Schaeffler Technologies AG & Co. KG, Herzogenaurach (DE)

(21) Appl. No.: 14/000,554

(22) PCT Filed: Feb. 15, 2012
(86) PCT No.: PCT/EP2012/052544

§ 371 Date: Jan. 6, 2014

(30) Foreign Application Priority Data
Feb. 21, 2011 (DE) 10 2011 004 434.5

(51) Int. Cl. G01B 11/27

(52) U.S. Cl. CPC G01B 11/27
USPC 356/138

(57) ABSTRACT

A laser alignment system (04) for measuring an alignment of rotating machine parts (01, 02), including at least one first laser transceiver (06). The first laser transceiver (06) includes an evaluation unit (12) and a web server (13) having a network interface for making data of the evaluation unit (12) available via a standardized communications protocol. A method for preprocessing measurement results of a laser alignment system (04), in which the measurement results are made available by a web server (13) and can be displayed in a client (17).

The present invention relates to a laser alignment system for measuring an alignment of rotating machine parts. The present invention also relates to a method for preprocessing the measurement results of a system of this type.

Alignment in this case is understood to be primarily a check for parallelism and/or axial offset, for example, of two shafts which are connected to each other by a coupling. Additional adjusting means may be used to carry out the actual alignment and to check it with the aid of the laser alignment system.

### BACKGROUND

Systems of this type are used wherever the precise alignment and/or measurement of machines, machine parts or other parts is/are necessary. They permit the measurement of an offset in the angle or position and/or a parallelism, for example for aligning generators and gears in wind turbines, for aligning machine, gear or propeller shafts or for aligning pumps and motors in all branches of industry.

Alignment devices according to the definition of the species typically include one or multiple laser measuring units, which are mounted on the rotating machine parts, and a display/control unit for configuring the measuring device and for reading the measured values.

A device and a method for determining the axial position of two machine spindles are described in DE 20 2009 017 510 U1. This device includes a first measuring unit, which has a light source and an optical detector, and a second measuring unit, which has a reflector prism. The measuring units are situated oppositely on the machine parts in such a way that the beam of the light source strikes the reflector prism in such a way that it is reflected in a locally resolved manner back to the detector situated in the first measuring unit. A misalignment may be determined from the migration of the point of incidence of the light beam on the detector during the conjoint rotation of the machine parts.

DE 101 09 462 A1 describes a device and a method for ascertaining the axial position of two spindles. The device includes an optical transmitting device and an optical receiving device, each of which is placed in at least three different rotational positions. Evaluation electronics ascertain a circle from the recorded points of incidence, from whose center point coordinates and radius the axial position may be inferred.

A device for aligning machine shafts is known from DE 101 32 142 A1, in which a portable computer having an input device and a display is provided for the purpose of interrogating mechanical or optical measuring means for determining the translatory and angular offset. With the aid of its optical transceiver device, the portable computer is initially used to detect the relevant machine dimensions. For this purpose, the portable computer must be manually oriented onto a central plane and held still during the measurement.

Various manufacturers offer laser alignment systems, each of which has a separate user interface having display and input means. For example, the Easy Laser system from the manufacturer, Dalmalini, has a display unit which includes a computer connected to the measuring units by cable or via wireless (Bluetooth) communication. The display unit includes a screen for displaying the measurement results and a keypad for entering data. After the measurement is complete, a report may be prepared in PDF format, including graphics and measured values, directly on the display unit of the measuring system. If desired, the measurements may be stored on a USB memory stick. The display unit may also be connected to a computer via the USB port for exchanging data.

### SUMMARY OF THE INVENTION

Due to their individual display units, which have separate data standards and interfaces, the known systems are expensive to manufacture and are not combinable among each other. The shaft alignment systems are generally each equipped with their own configuration and evaluation software which does not permit communication with conventional terminals such as PDAs, laptops, smart phones or the like.

It is an object of the present invention to provide a laser alignment system which is cost-effective to manufacture and which has improved display and evaluation means which may preferably be used across systems.

A laser alignment system according to the present invention includes at least one first laser transceiver unit and one first reflector, which are designed in the known way.

The laser transceiver unit includes an evaluation unit and a web server having a suitable network interface. A LAN, WLAN or WAN network is preferably used. It is likewise possible to set up a peer-to-peer network which meets the necessary functionalities. Those skilled in the art may select the suitable technology according to the requirements.

The web server is used to provide data from the evaluation unit, using a standardized communication protocol, which may be evaluated by different remote devices.

The advantages of the present invention may be seen, in particular, in that the manufacturer-specific handheld devices previously required may be dispensed with because the data of the web server may be displayed in a web browser or special clients using any common Internet-capable terminal.

For example, PDAs, tablets, smart phones or laptops may be used as terminals. The terminal need only be equipped with an Ethernet adapter, preferably a WLAN adapter, or have access to the web server-generated data via another standard interface.

The web server is preferably designed as software which runs on a computer with the evaluation unit. For example, a Linux platform may run on the computer. Computers of this type are presently used in the area of entertainment electronics.

A method according to the present invention for processing measurement results of a laser alignment system is characterized in that measurement results are preferably stored in a database which is connected to the web server. On request, the web server generates dynamic pages, including the data stored in the database, with the aid of a client. For example, a text file, a comma-separated list or the like or even a fixed memory area may, of course, be used instead of a database, provided that it is ensured that the web server has access to the stored measurement results. The dynamic pages are preferably provided via a local intranet. Of course, a connection to the interne is also possible, so that global services, for example, are also possible in special application situations.

In order for a common web browser to be sufficient for displaying and possibly further processing the data by the user or in the terminal, dynamic web pages having program modules are generated on the web server page. Therefore, the web server is actually a web application server. The database-linked web pages may be generated using different technologies. For example, Pearl, CGI, ASP, PHP or JAVA should be mentioned here. Those skilled in the art will select and correspondingly implement the most suitable technology according to the application.

JAVA with JSP (Java Server Pages) appears to be particularly suitable. It may be used in different industrial operating systems and offers many advantages, such as the use of the standard, future-oriented, powerful, modern and well structured Java programming language, powerful, standardized libraries, easy and fast database connection, good networking capability, component technology, distributed applications and enterprise functions. The programming language may also be used in the client (e.g., if HTML forms are insufficient, such as for JTable or graphical representations).

Of course, it should be possible to implement all functions of the previously known display units on the client. A standard browser may preferably be used as the client on the terminal. However, it is also possible to use a specially programmed client, which must then be installed on the terminal.

The client may be used to transmit queries to the web server or to send data. The input and configuration options are designed similarly to the known devices.

The displayed web site, including the representation, operation and navigation, may be set up in the same way as the displays of conventional laser alignment systems. Only user-oriented limits are imposed on the design and integration of data.

Due to the server technology, the data may be provided in different formats for different terminals.

### BRIEF DESCRIPTION OF THE DRAWINGS

Preferred specific embodiments of the present invention are illustrated in the following drawings.

FIG. 1 shows a schematic representation of a first preferred specific embodiment of a laser alignment system according to the present invention for aligning two shafts;

FIG. 2 shows a schematic representation of a second preferred specific embodiment of a laser alignment system according to the present invention for aligning two shafts;

FIG. 3 shows a schematic representation of a third preferred specific embodiment of a laser alignment system according to the present invention for aligning two shafts.

### DETAILED DESCRIPTION

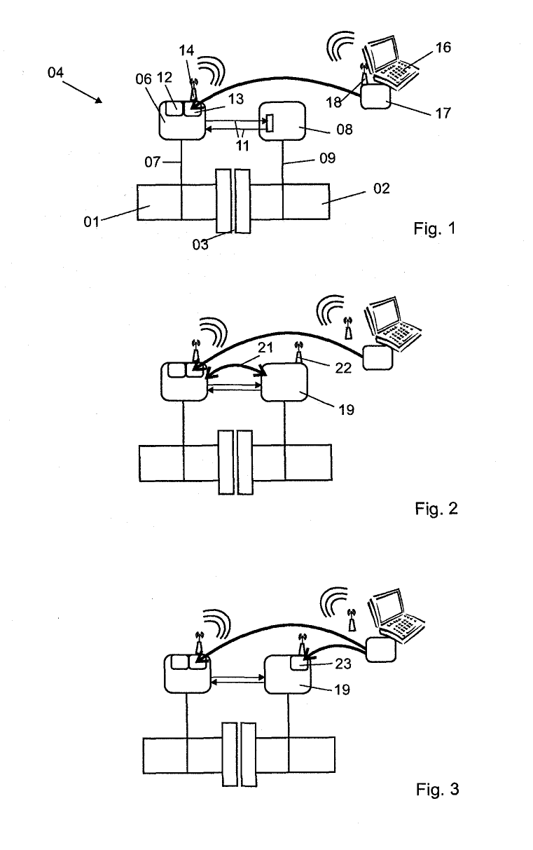

FIG. 1 shows a schematic representation of a first preferred specific embodiment of the present invention. In this specific embodiment, a first shaft 01 and a second shaft 02 are connected with the aid of a coupling 03. The correct alignment of shafts 01, 02 in relation to each other is carried out with the aid of a laser alignment system 04 according to the present invention.

For this purpose, a laser transceiver unit 06 is connected to first shaft 01 in the known way with the aid of a first support 07. A reflector 08 is connected to second shaft 02 with the aid of a second support 09. Reflector 08 is oriented in such a way that it reflects a laser beam 11, which is emitted by laser transceiver unit 06, back to laser transceiver unit 06. Based on the point of incidence of laser beam 11 in a detector of laser transceiver unit 06, which is not illustrated, the deviation in the alignment of shafts 01 and 02 in relation to each other may be inferred. This method may be carried out or varied according to all possibilities known according to the related art.

The present invention is based on the fact that transceiver unit 06 includes an evaluation unit 12 and a web server 13 having a network interface 14, which is preferably designed as a wireless network interface.

The transceiver unit may also include a router. Both web server 13 and the router may be designed as software or hardware. Those skilled in the art know the requirements and implementation capabilities of the different technologies.

Evaluation unit 12 operates in the previously known way. It preferably includes a database in which the ascertained values are stored. In modified specific embodiments, the storage may also take place in other ways known to those skilled in the art.

A preferably database-supported server application runs on web server 13, which processes the data from the database or other data sources for display.

In the illustrated specific embodiment, a laptop 16 is used as the terminal or display unit (preferably designed as a handheld device), on which, for example, a web browser runs as client 17. Laptop 16 has a preferably WLAN-capable Ethernet adapter 18.

To display the measurement results, client 17 starts a query for web server 13, which generates a corresponding, dynamic web page, which is transmitted to client 17, for example with the aid of the standard HTTP protocol, and is displayed accordingly on the screen of laptop 16.

Inputs on laptop 16 are also possible in the known way, which are used to configure the measuring system or evaluate the data. These data may be transmitted to web server 13 and stored there in the database. The data may also be summarized on another web page, for example in the form of measuring reports.

An alternative specific embodiment is illustrated in FIG. 2. This figure differs from the approach described in FIG. 1 in that laser alignment system 04 has a second laser transceiver unit 19 instead of reflector 08. With regard to the actual measurement, this system also operates in a way which is known per se; only the communication between the two laser transceiver units 06, 19 also takes place via a wireless connection 21, according to the present invention. For this purpose, second laser transceiver unit 19 is provided with a corresponding transceiver unit 22 for transmitting/receiving data and/or control commands.

The specific embodiment illustrated in FIG. 3 differs from the one illustrated in FIG. 2 in that second laser transceiver unit 19 is equipped with a separate, second web server 23. This eliminates direct data exchange 21 between laser transceiver units 06, 19.

Of course, laser alignment system 04 described herein may be used for a wide range of applications. It is not limited to the specific embodiments illustrated herein.

### LIST OF REFERENCE NUMERALS

01—First shaft
02—Second shaft
03—Coupling
04—Laser alignment system
06—First laser transceiver unit
07—First support
08—Reflector
09—Second support
11—Laser beam
12—Evaluation unit
13—Web server
14—Network interface
16—Laptop
17—Client
18—Ethernet adapter
19—Second laser transceiver unit
21—Data exchange
22—Transceiver unit
23—Second web server

What is claimed is:

1-10. (canceled)

11. A laser alignment system for measuring an alignment of rotating machine parts comprising:
at least one first laser transceiver unit, the first laser transceiver unit including an evaluation unit and a web server having a network interface for providing data of the evaluation unit via a standardized communication protocol.

12. The laser alignment system as recited in claim 11 wherein the network interface is a wireless network interface.

13. The laser alignment system as recited in claim 11 further comprising a reflector or a second laser transceiver unit.

14. The laser alignment system as recited in claim 13 further comprising the second laser transceiver unit, the second laser transceiver unit including a second web server.

15. The laser alignment system as recited in claim 11 wherein the web server is provided by software.

16. The laser alignment system as recited in claim 11 further comprising a router.

17. The laser alignment system as recited in claim 11 further comprising a terminal remote from the evaluation unit and configured as a client able to access the data provided by the web server.

18. The laser alignment system as recited in claim 17 wherein the remote terminal is a PDA, tablet, smart phone or laptop.

19. A method for processing measurement results of a laser alignment system comprising the following steps:
storing the measurement results;
generating and providing a dynamic document, the dynamic document including at least the measurement results, with the aid of a web server; and
transmitting the dynamic document to a client with the aid of a standardized protocol.

20. The method as recited in claim 17 wherein configuration data entered via the client permitting the alignment system to be configured is transmitted to the web server.
